(19) United States
(12) Patent Application Publication
(10) Pub. No.: US 2005/0053099 A1
(43) Pub. Date: Mar. 10, 2005

(54) Timing advance determinations in wireless communications devices and methods

(76) Inventors: Stephen L. Spear, Skokie, IL (US); Charles P. Binzel, Bristol, WI (US); Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/656,568

(22) Filed: Sep. 5, 2003

(51) Int. Cl. H04J 3/06

(52) U.S. Cl. 370/508; 370/343

(57) ABSTRACT

A method in a wireless communications device including obtaining timing advance, for example, by determining (430) timing advance based on a distance of the wireless device from a base transceiver station. In some embodiments, the timing advance and corresponding location information is stored in a look-up table on the wireless device. The look-up table data may be populated or updated from timing advance information generated on the wireless device and/or obtained from some other source. In some embodiments, the wireless device transmits a modified access or normal burst when using a timing advance determined on the wireless communications device.

### FIELD OF THE DISCLOSURE

The present disclosure relates generally to wireless communications, and more particularly to obtaining timing advance and the management thereof in wireless communications devices, for example, in wireless communications devices connected to packet networks, and methods.

### BACKGROUND OF THE DISCLOSURE

In the existing Global System for Mobile Communications (GSM), which is a TDMA system, and General Packet Radio Service (GPRS), the mobile station (MS) need to adjust its transmissions to arrive at the base station transceiver (BTS) at a specific time. This is referred to as timing advance. Presently, the GSM/GPRS standard, at GSM 05.01, specifies that timing advance determinations be made in the BTS of the base station system (BSS). When an MS first attempts to communicate with a BTS, the MS uses an access burst with identification and essential overhead information, for example, synchronization sequence, etc. The access burst includes guard time, which prevents interference with communications on neighboring timeslots. The access burst is currently defined at 05.02 of the GSM standard. In packet networks the access burst is relatively small to permit greater numbers of subscribers to gain channel access. Due to the shared nature of the timeslot and lack of a dedicated signaling channel, the MS must send an access burst with each new channel or sub-channel allocation.

The GSM standard, at GSM 05.01, describes extended cells where the timing advance is insufficient to correct for the distance of the MS relative to the BTS, for example, in cells where the distance is greater than 35 km.

U.S. Pat. No. 5,642,354 entitled “Enhanced Access Burst In A Wireless Communication System” describes an enhanced access burst that may contain information, for example, short messages, in addition to information, e.g., identification and essential overhead information, typical of access bursts.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary communications network.

FIG. 2 illustrates the timing advance in a time division multi-frame communications system.

FIG. 3 is an exemplary process for determining timing advance.

FIG. 4 is another exemplary process for obtaining timing advance.

FIG. 5 is an exemplary scheme for determining the location of a bases station.

FIG. 6 is another exemplary process for determining timing advance.

FIG. 7 illustrates an exemplary prior art access burst.

FIG. 8 illustrates a modified access burst.

FIG. 9 illustrates an exemplary prior art normal burst.

FIG. 10 illustrates a modified normal burst.

### DETAILED DESCRIPTION

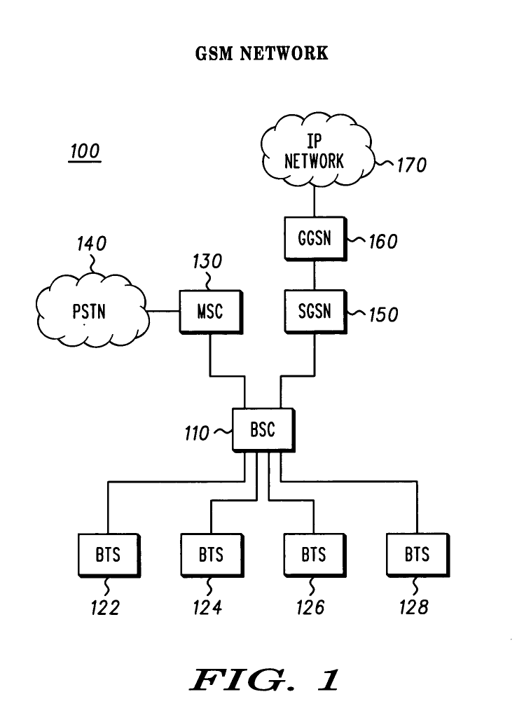

In FIG. 1, the exemplary Global System for Mobile (GSM) communications network 100 includes a base station controller (BSC) 110 communicably coupled to a plurality of base transceiver stations 122, 124, 126, 128, each of which support communications with wireless communications devices within a designated area, or cell. In the exemplary GSM network architecture, the BSC 110 is also communicably coupled to a mobile switching center (MSC) 130, which is communicably coupled to a public switched telephone network (PSTN) 140, thereby enabling communications between wireless communications devices and plain old telephone service (POTS) devices. The exemplary BSC is also coupled to a Serving GPRS Support Node (SGSN) 150, which provides mobility and data session management for General Packet Radio Service (GPRS) enabled wireless communications devices. The SGSN is coupled to a Gateway GPRS Support Node (GGSN) 160 that enables wireless devices to communicate with other networks, for example Internet Protocol (IP) network 170. The exemplary GSM communications network is not limiting as the disclosure is applicable to other communications networks including for example, other time division multi-frame (TDM) and time division multiple access (TDMA) networks.

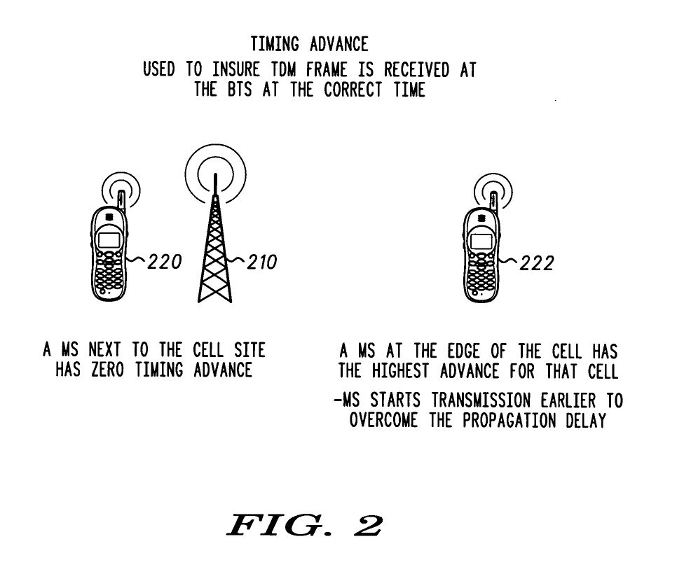

FIG. 2 illustrates a wireless communications network base station 210 and a first wireless communications device 210 adjacent near the base station and another wireless communications device 222 near the out limit of the area covered by the base station 210. The wireless device 210 next to the base station requires zero timing advance (TA) to synchronize its communications with the base station. The wireless device 222 near the edge of the coverage area has a relatively high timing advance. The timing advance of the wireless device ensures that radio transmissions by the wireless devices are received at the base station at the correct time.

In some embodiments, the wireless device has stored thereon a look-up table providing timing advance information associated with different locations relative to one or more base stations. This information may be accumulated over time and updated periodically. The timing advance information may be obtained from the network or the wireless device may determine the timing advance information as discussed below. A wireless device having knowledge of its location may obtain timing advance information from the look-up table.

In the process diagram of FIG. 3, at block 310, a wireless device obtains it current location. A wireless device enabled with a satellite positioning system (SPS) receiver, for example, a NAVSTAR Global Positioning System (GPS) receiver may obtain an SPS based location fix, e.g., by computing the SPS location fix locally or by sending pseudorange information to the communications network for computation of the location fix, which would be returned to the wireless device. Alternatively, the location of the wireless device may be computed by means other than an SPS receiver, for example, using network resources including one of more base stations and/or location measurement units (LMUs). These schemes include Enhanced Observed Time Difference (E-OTD), Angle of Arrival (AoA), Time of Arrival (TOA), Time Difference of Arrival (TDOA), among other location determination schemes.

In FIG. 3, at block 320, a determination is made whether the wireless device is within a specified distance of a location in the look-up table for which timing advance information is provided, for example, within 100 meters of a location for which the look-up table include timing advance information. In one embodiment, at block 330, the look-up table timing advance information is used only if the location of the wireless device is within the specified distance. At block 335, the wireless device uses the timing advance for its communications with the base station.

If the location of the wireless device is not within a specified distance of a location in the look-up table for which timing advance information is provided, the wireless device obtains timing advance information from a source other than the look-up table. In one embodiment in FIG. 3, at block 340, the network provides the timing advance information to the wireless device, for example, as is known conventionally. In other embodiments, timing advance information is determined by the wireless device as discussed below.

In FIG. 3, at block 350, the look-up table is updated with the new timing advance information for the new location. In some embodiments, it may be desirable to limit the size or amount of timing advance and location data stored in the look-up table, for example, by storing timing advance information for only frequently used locations, e.g., work, home, etc. In other embodiments, the wireless device determines timing advance or obtains it from the network without using a look-up table.

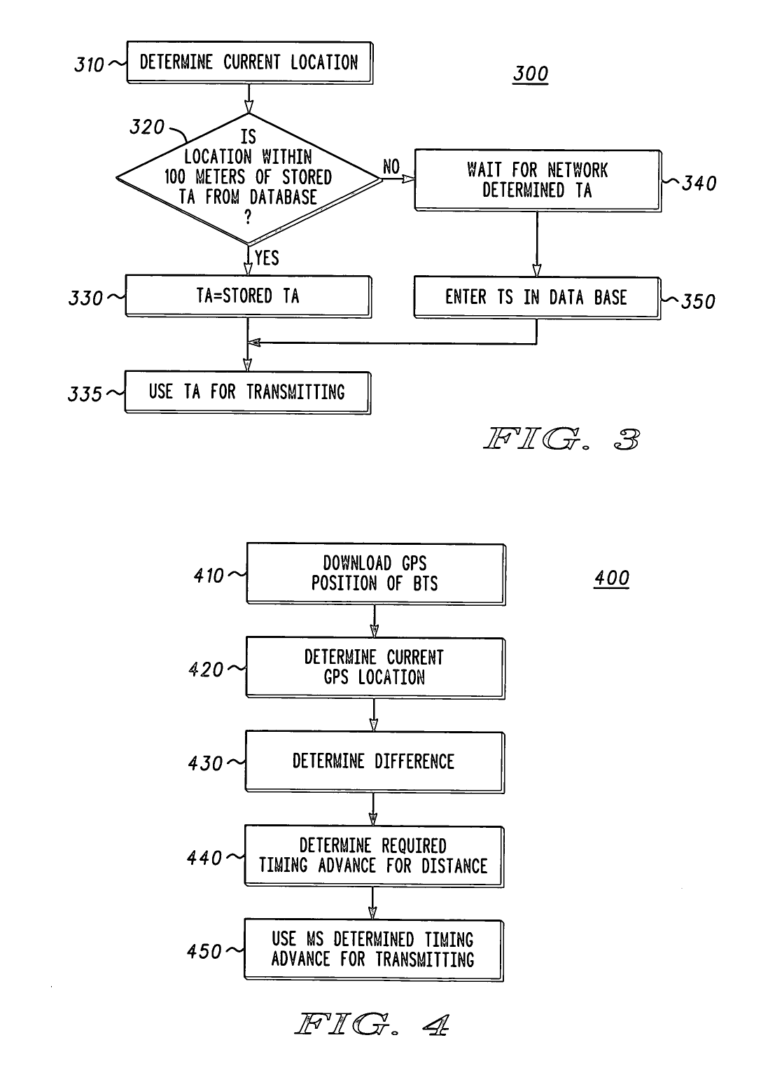

In some embodiments, the wireless device determines timing advance, for example, based on a distance of the wireless communications device from the base station. In the exemplary process diagram 400 of FIG. 4, at block 410, the wireless device obtains the location of the base station, for example, by downloading the base station location coordinates. The wireless device may download the coordinates for several frequently used base stations and store them in the look-up table. At block 420, the wireless device determines a difference between the locations and computes the distance of the wireless device from the bases station. At block 440, the wireless device computes the timing advance for distance computed, and at block 450 the timing advance is used for communications with the base station. As suggested, above, the timing advance computed and the corresponding location or distance may be stored in the look-up table for future use. The wireless communications device may also determine timing advance from a known propagation delay between the wireless device and the base station.

In some embodiments, the look-up table includes location information for one or more base stations. With this information, a wireless device with a known location may compute its distance from the base station, and thus determine timing advance and/or propagation delay. In one embodiment, the base station location information, e.g., in latitude/longitude coordinates or in some other useful format, may be downloaded onto the wireless device, for example, in an over-the-air message. In another embodiment, the wireless device may compute the location of one or more base stations and populate the look-up table with the location information computed for the base stations.

In one embodiment, the location of the base stations is determined based on known timing information, for example, propagation delay or timing advance, for two or more known locations of the wireless device relative to the base station. In FIG. 5, a wireless device 510 with known timing information t₁ & t₂ at corresponding known locations (x₁, y₁) & (x₂, y₂) relative to a base station 520 may compute the unknown location (x₃, y₃) of the base station using the following relations:
t₁=k*SQRT[(x₃−x₁)²+(y₃−y₁)²] Eqn. (1)
t₂=k*SQRT[(x₃−x₂)²+(y₃−y₂)²] Eqn. (2)
where “k” is a constant, and t₁ & t₂ are known timing relations between the wireless device 510 and base station 520. The timing information t₁ & t₂ may be propagation delay or timing advance information or some other known timing information. Eqns. (1) & (2) above may be manipulated algebraically to solve for the unknown base station location (x₃, y₃).

For a wireless device that is in the same cell as it was on during an earlier transmission, the wireless device may compute propagation delay by comparing an offset during the earlier transmission with a current received signal. This requires that the wireless device maintain the offset and timing advance during the earlier transmission current The new timing advance may be determined from the known timing advance from the earlier transmission and the difference in the timing offsets. This scheme for computing timing advance at the wireless device may be used with or without location information.

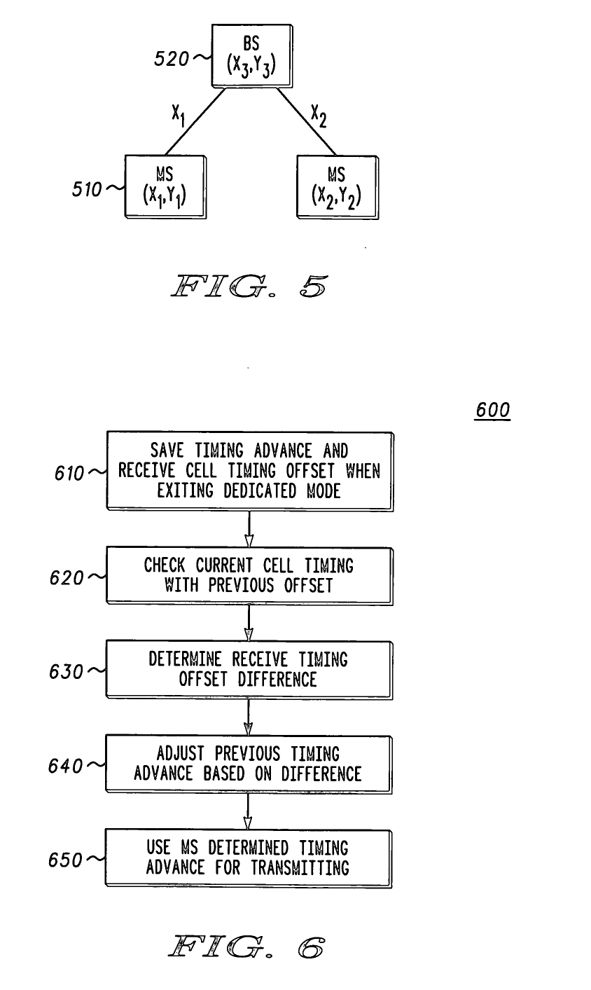

In the process diagram 600 in FIG. 6, at block 610, the wireless device stores timing advance and timing offset information, for example, when exited dedicated mode on a particular serving cell. At block 620, at a later time, within the same serving cell, for example, upon leaving and reentering the cell or upon moving to another location within the cell, the wireless device determines the current cell timing, for example, using the previous cell timing. At block 630, a cell timing offset difference is determined based on the current and previous cell timing information. At block 640, the new timing advance is determined by adjusting the previous timing advance using the cell timing difference. There after, at block 650, the wireless device uses the new timing advance for subsequent transmissions.

The determination of timing advance in the wireless device may in be inaccurate in some instances for any number of reasons. In some embodiments, the mobile terminal may use a modified burst to compensate for any potential error in the timing advance determined at the wireless device. In one exemplary embodiment, the mobile terminal uses a modified access burst to compensate for the potential error in the timing advance, and in another exemplary embodiment the wireless device uses a modified normal burst to compensate for the potential error in the timing advance.

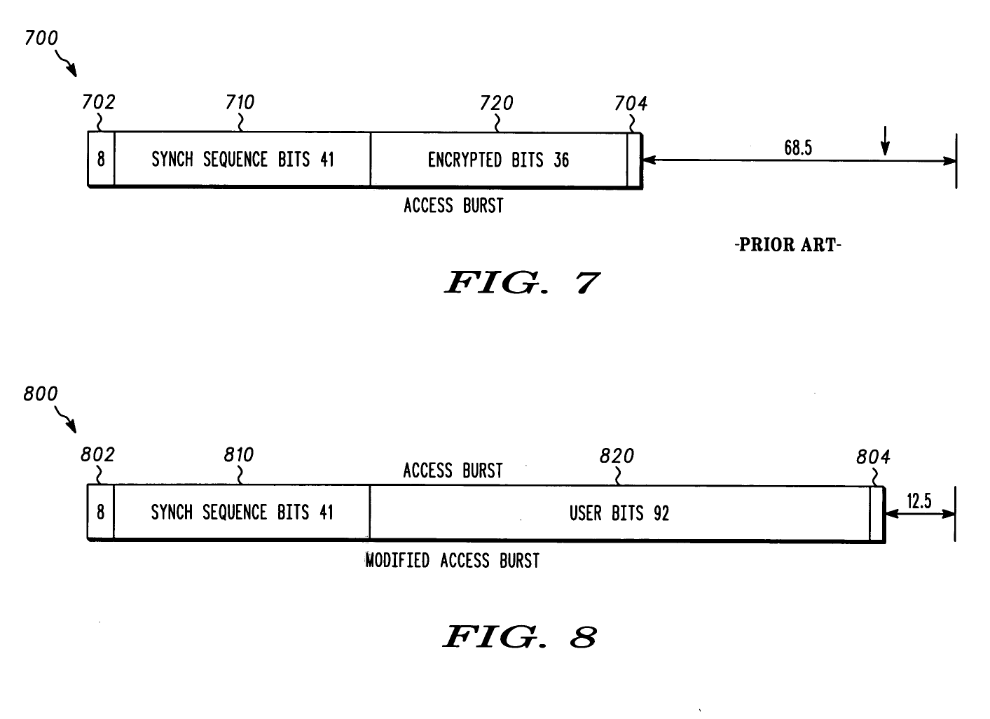

FIG. 7 is an exemplary prior art GSM access burst 700 comprising a 41 Synch Sequence bits 710 and 36 encrypted bits 720, also known as user bits, which may be used for sending information to the base station. The beginning and ending of the burst each have tail bits 702, 704, respectively. The prior art access burst also includes a relatively large guard time, which is 68.5 bits in the exemplary embodiment of FIG. 7. The guard bits prevent the access burst from interfering with neighboring time-slots. The guard time is relatively large since the timing advance is unknown, and the guard time is selected to ensure no interference for when the wireless device is located a maximum distance from the network. Other prior art access bursts may have different numbers of bits and guard times. The normal access burst is defined by the communications standard to which it pertains. The network, e.g., the BTS in FIG. 1, sends the timing advance to the wireless device in response to receiving the normal access burst.

In embodiments where the wireless device determines timing advance, there is substantially less uncertainty about the accuracy of the timing advance than when the wireless device transmits a random access burst without knowledge of the timing advance. FIG. 8 illustrates an exemplary modified access burst 800 comprising 41 synch bits 810 and 92 bits 820, also known as encrypted bits, which may be used for sending information to the base station. The beginning and ending of the burst each have tail bits 802, 804, respectively. The modified art access burst is distinguished from normal access burst by its reduced guard time, which is 12.5 bits in the exemplary embodiment of FIG. 8. The reduced guard time is permissible since the wireless device has some knowledge of its timing advance. The reduced guard time permits additional user bits, which may be used for transmitting data. The numbers of bits and guard time in the modified access burst of FIG. 8 is exemplary. Other modified access bursts may have other guard times. For example, the guard time may be selected based on the accuracy with which the timing advance is known. In some embodiments, the guard time may be selected dynamically, dependent on the certainty with which the timing advance is known. Thus in some embodiments where the wireless device determines timing advance, a modified access burst may be used. For example, the wireless device may use a locally determined timing advance and a modified access burst to obtain precise timing advance from the network.

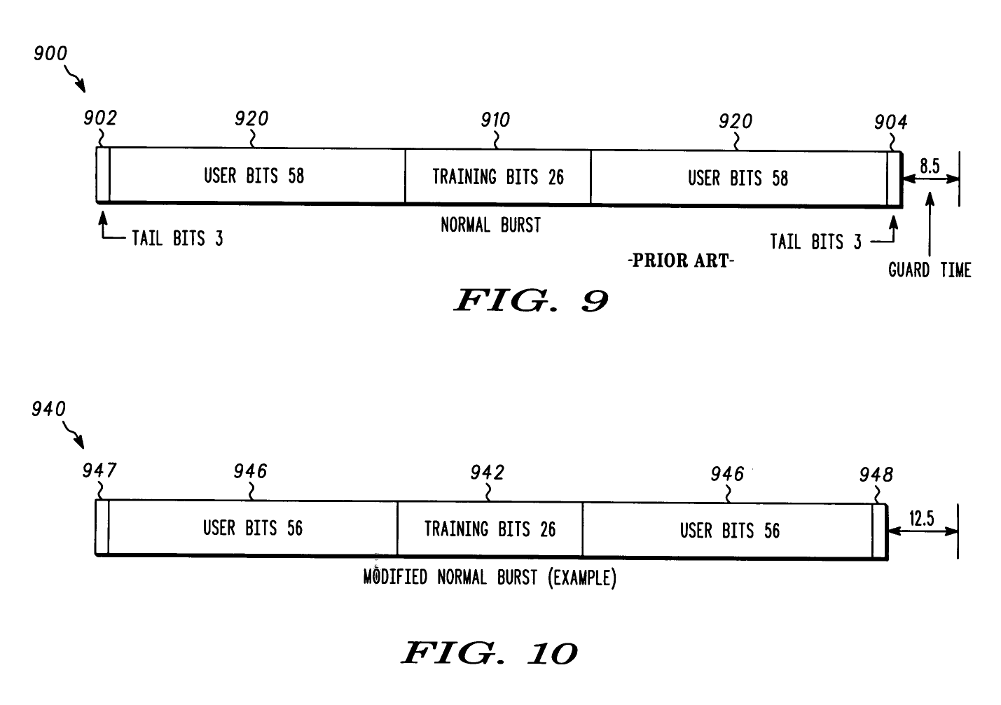

FIG. 9 is an exemplary prior art GSM normal burst 900 comprising 26 training bits 910 flanked by user bit portions 920, which are be used for sending information. The beginning and ending of the burst also includes tail bits 902, 904, respectively. The prior art normal burst also includes guard time, which is 8.5 bits in the exemplary embodiment of FIG. 8. The guard time prevents the burst from interfering with neighboring time-slots. In the normal burst, the guard time is relatively small since the timing advance is already known. The prior art normal burst is defined by the communications standard to which it pertains.

In another embodiment, where the wireless device computes timing advance, instead of using a normal or modified access burst, the wireless device may use a modified normal burst, which has an enlarged guard time relative to the guard time of a prior art normal burst. The enlarged guard time of the modified normal burst compensates for any inaccuracy in the timing advance computed by the wireless device. Upon receiving the precise timing advance from the network, the wireless device may use un-modified normal bursts.

FIG. 10 illustrates an exemplary modified normal burst 940 comprising 26 training bits 942 flanked by user bit portions 946, which are be used for sending information. The beginning and ending of the burst also includes tail bits 947, 948, respectively. The exemplary modified normal burst also includes an increased guard time, which is 12.5 bits in the exemplary embodiment of FIG. 10, relative to the prior art normal burst. In the exemplary embodiment of FIG. 10, the increased guard time is obtained by reducing the available number of bits.

In one embodiment, the mobile terminal uses a modified access burst with more information leaving sufficient guard time to compensate for any potential error in the timing advance. In another embodiment, the wireless device uses a modified normal burst with slightly fewer bits and a longer guard time to compensate for potential error in the wireless device determined timing advance.

In some embodiments where the wireless device sends a modified burst, e.g., a modified access burst or a modified normal burst, the base station provides timing advance information correction, rather than an absolute timing advance assignment. The timing advance correction is the difference between the timing advance computed by the wireless device and the actual timing advance. The network determines that the wireless device computed an estimated timing advance upon decoding a burst received from the wireless device. For example, the network may compute the correction based on the time difference between when the burst was received and when the network wants to receive the burst. Thus, in some embodiments, it is unnecessary for the wireless device to send its estimated timing advance, since the network may compute a correction without the estimate. In one embodiment, the network sends the wireless device a correction when assigning a dedicated channel. Once the wireless device is on a dedicated channel, there is a associated control channel that the wireless device uses to communicate its current timing advance to the network. It may be possible that the wireless device is never assigned a dedicated channel, and that all of the required information is provided using the new bursts and the estimated timing advance. The timing advance correction is used by the wireless device to correct the timing advance determined by the wireless device.

The determination of the timing advance on the wireless device and/or the use of a look-up table having timing advance information reduce the time to exchange information with base stations. It may also reduce delays associated with reselection or handover. In embodiments where modified bursts are used, information may be sent over the modified bursts without shrinking the coverage area of the cell and without interfering with devices assigned to adjacent timeslots. The disclosure thus has value in applications where it is desirable to minimize data interruption, for example, where voice is transmitted over packet networks, including push-to-talk applications over GPRS networks, and where fast connection setup times are desirable.

While the present disclosure and what the best modes of the inventions have been described in a manner establishing possession thereof by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a wireless communications device, the method comprising:
determining a distance of the wireless communications device from a base station;
determining timing advance, at the wireless communications device, for the base station based on the distance of the wireless communications device from the base station;
using the timing advance determined for transmitting to the base station.

2. The method of claim 1,
determining a location of the wireless communications device,
determining the distance of the wireless communications device from the base station using the location of the wireless communications device and a location of the base station.

3. The method of claim 2, the wireless communications device includes a satellite positioning system receiver, determining the location of the wireless communications device by obtaining a satellite positioning system based location fix.

4. The method of claim 2, obtaining the location of the base station based on known timing advance information for different locations with a cell served by the base station.

5. The method of claim 2, obtaining the location of the base station based by receiving a message including base station location information.

6. The method of claim 2, obtaining the location of the base station from a table of base station locations stored on the wireless communications device.

7. The method of claim 6, obtaining the base station locations stored in the table by downloading to the wireless communications device.

8. The method of claim 1, determining the timing advance at in the wireless communications device for transmitting voice over a packet network.

9. The method of claim 1, determining the timing advance at in the wireless communications device during a push-to-talk session over a packet network.

10. A method in a wireless communications device, the method comprising:
determining a propagation delay between the wireless communications device and a base station;
determining timing advance, in the wireless communications device, for the base station based on the propagation delay between the wireless communications device and the base station;
using the timing advance determined for transmitting to the base station.

11. The method of claim 10,
obtaining satellite positioning system time from a satellite positioning system,
obtaining satellite positioning system time from the base station,
determining propagation delay using the satellite positioning system time from the satellite positioning system and the satellite positioning system time from the base station.

12. A method in a wireless communications device, the method comprising:
obtaining first timing information for the wireless communications device at a first known location relative to a base station;
obtaining second timing information for the wireless communications device at a second known location relative to the base station;
determining a location of the base station based on the first and second timing information and based on the first and second known locations.

13. A method in wireless communications device, the method comprising:
determining a difference between a current cell timing and a prior cell timing for a common serving cell;
determining a current timing advance for the common serving cell using the difference between the current cell timing and the prior cell timing and using a prior timing advance corresponding to the prior cell timing.

14. The method of claim 13,
using the current timing advance for communicating with the network,
determining the current timing advance before communicating with the network.

15. A method in a wireless communications device having a look-up table providing timing advance information associated with different locations relative to at least one base station, the method comprising:
determining a location of the wireless communications device;
determining timing advance information for the location of the wireless communication device from the look-up table.

16. The method of claim 15, determining timing advance information for the location of the wireless communication device using timing advance information in the look-up table only if the location of the wireless communications device is within a specified distance of a location in the look-up table for which timing advance information is provided.

17. The method of claim 15, obtaining timing advance information from a source other than the look-up table if the location of the wireless communications device is not within a specified distance of a location in the look-up table for which timing advance information is provided.

18. The method of claim 15, updating the look-up table with the timing advance information obtained from the source other than the look-up table.

19. The method of claim 18, determining timing advance information from the look-up table when communicating voice over a packet network.

20. A method in a wireless communications device, the method comprising:
determining timing advance on the wireless communications device;
transmitting a modified burst to a network using the timing advance determined on the wireless communications device.

21. The method of claim 20,
transmitting the modified burst includes transmitting a modified access burst having a reduced guard time relative to an un-modified access burst.

22. The method of claim 20,
transmitting the modified burst includes transmitting a modified normal burst having a an increased guard time relative to an un-modified normal access burst, without first transmitting an access burst.

23. The method of claim 20, receiving a timing advance correction from the network after sending the modified burst to the network.
